(19) United States
(12) Patent Application Publication
(10) Pub. No.: US 2006/0113789 A1
(43) Pub. Date: Jun. 1, 2006

(54) Encrypted-data game card

(76) Inventor: Chang-Han Lin, Taipei City (TW)

Correspondence Address: TROXELL LAW OFFICE PLLC, SUITE 1404, 5205 LEESBURG PIKE, FALLS CHURCH, VA, 22041, US

(21) Appl. No.: 11/271,897

(22) Filed: Nov. 14, 2005

(30) Foreign Application Priority Data
Nov. 26, 2004 (TW) 093219003

(51) Int. Cl. B42D 15/00

(52) U.S. Cl. 283/109

(57) ABSTRACT

The present invention provides a game card which contains encrypted data to be recognized by watching from various visual angles or through a filter lens so that a good concealment and a high amusement are obtained.

### FIELD OF THE INVENTION

The present invention relates to a game card; more particulary, relates to encrypting data and recognizing various parts of data by watching from various visual angles or by watching through a filter lens so that a good concealment and a high amusement are obtained.

### DESCRIPTION OF THE RELATED ARTS

A hidden image can be a word, a number, a figure, a trademark, a photo, a description, a message, a pattern or a marking of a specific form. For example, when a hidden image is used in a game card, the image can be shown as a special name, a special number, a special phrase, a special photo, a special picture, a special trademark or a special figure for winning a specific award.

There are several ways to obtain a substrate with a hidden image. For example, some kinds of hidden image on substrate can be shown only after applying a specific chemical solution. Or, a specific substrate with a kind of hidden image shows the image only after the substrate basks in the sun or an artificial light.

Or, a scrape lottery is a paper card printed with a hidden image in a specific area and the area is covered with a covering layer to be scraped off. When the user wants to check if an award is won, the covering layer is scraped off and the hidden image is shown to know the result. But, the covering layer is on the outside surface and can be scraped by a sudden collision so that the concealment is not good while the amusement is low. Hence, the prior arts do not fulfill users' requests on actual use.

### SUMMARY OF THE INVENTION

The main purpose is to provide a game card with encrypted data and various parts of data are recognized by watching from various visual angles or through a filter lens so that a good concealment and a high amusement are obtained.

To achieve the above purpose, the present invention is an encrypted-data game card, comprising a base layer; an absorbing layer deposed on the base layer; a first blurring layer deposed on the absorbing layer, comprising a first sectioned image area; a first data layer deposed on the first blurring layer, comprising a first image area; a second blurring layer deposed on the first data layer, comprising a second sectioned image area; and a second data layer deposed on the second blurring layer, comprising a second image area and a first grating. Accordingly, a novel encrypted-data game card is obtained.

### BRIEF DESCRIPTIONS OF THE DRAWINGS

The present invention will be better understood from the following detailed descriptions of the preferred embodiments according to the present invention, taken in conjunction with the accompanying drawings, in which

FIG. 1 is an explosive view of a first preferred embodiment according to the present invention;

FIG. 2 is a perspective view of the first preferred embodiment according to the present invention;

FIG. 3 is a cross-sectional view of the first preferred embodiment according to the present invention;

FIG. 4 is a cross-sectional view of a second preferred embodiment according to the present invention;

FIG. 5 is a state-of-use view of the second preferred embodiment according to the present invention;

FIG. 6 is a cross-sectional view of a third preferred embodiment according to the present invention;

FIG. 7 is a state-of-use view of the third preferred embodiment according to the present invention;

FIG. 8 is a cross-sectional view of a fourth preferred embodiment according to the present invention;

FIG. 9 is a state-of-use view of the fourth preferred embodiment according to the present invention; and

FIG. 10 is a cross-sectional view of a fifth preferred embodiment according to the present invention.

### DESCRIPTION OF THE PREFERRED EMBODIMENTS

The following descriptions of the preferred embodiments are provided to understand the features and the structures of the present invention.

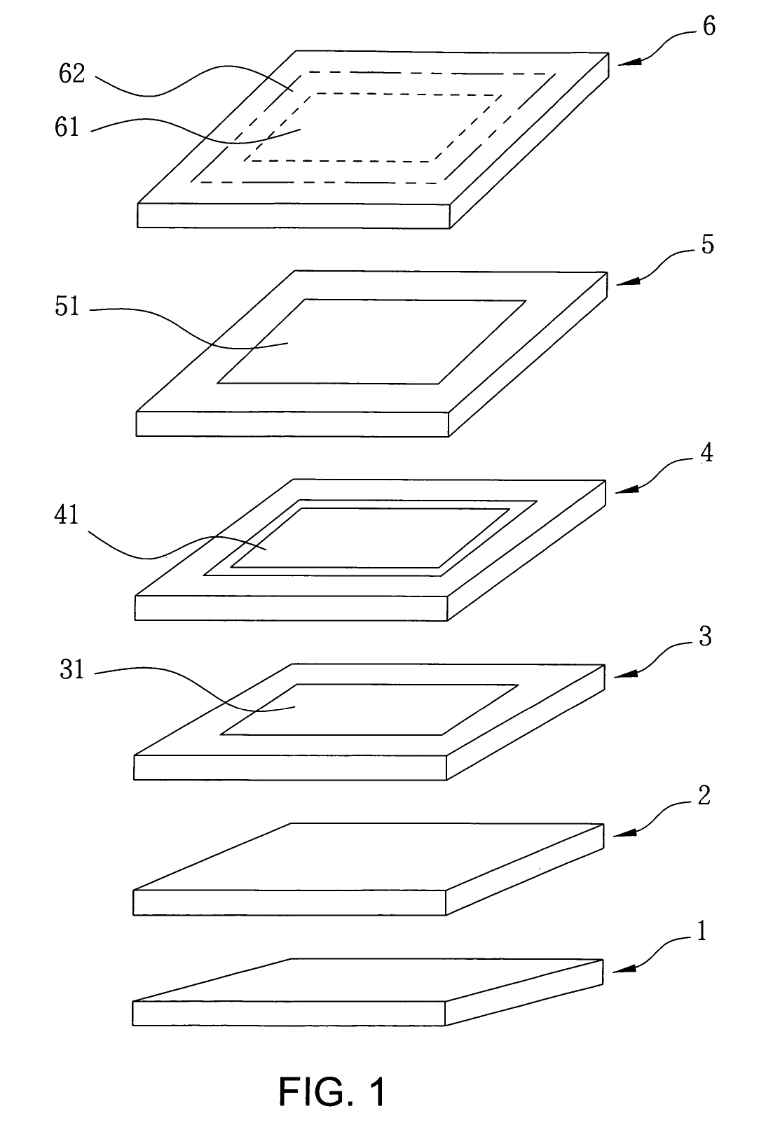

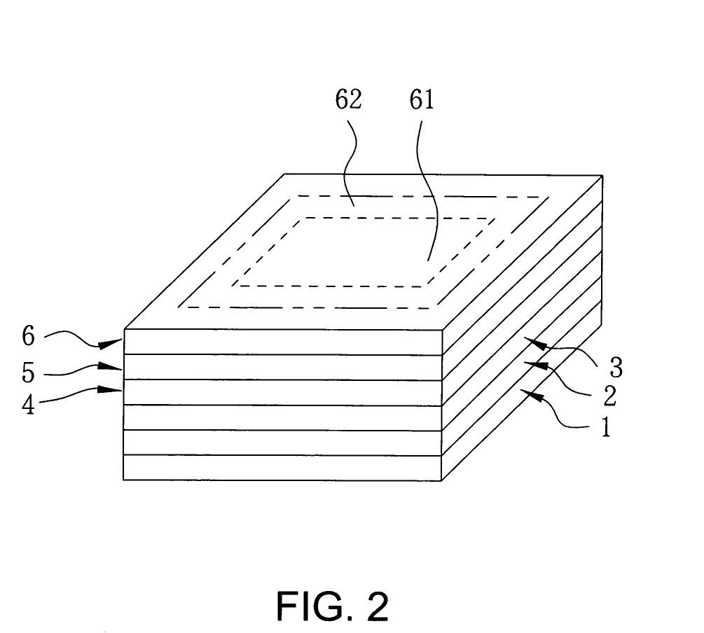

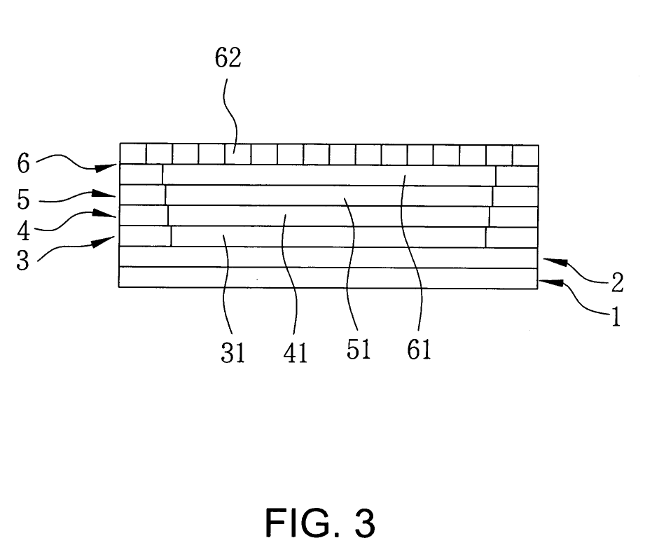

Please refer to FIG. 1 through FIG. 3, which are an explosive view, a perspective view and a cross-sectional view of a first preferred embodiment according to the present invention. As shown in the figures, the present invention is an encrypted-data game card, comprising a base layer 1, an absorbing layer 2, a first blurring layer 3, a first data layer 4, a second blurring layer 5 and a second data layer 6, where data is encrypted in the game card and is recognized by watching from various visual angles or through a filter lens so that a good concealment and a high amusement are obtained.

The base layer 1 is made of a plastic film, a transparent material or a semi-transparent material.

The absorbing layer 2 is deposed on the base layer 1 for absorbing light source so that the first data layer 4 obtains better concealment.

The first blurring layer 3 is deposed on the absorbing layer 2, where the first blurring layer 3 comprises a first sectioned image area 31 and the first sectioned image area 31 is sectioned according to a geometric figure, such as circularly sectioned or wavily sectioned.

The first data layer 4 is deposed on the first blurring layer 3, where the first data layer 4 comprises a first image area 41 and the first image area 41 comprises an image which is a blank image with a border line. And, the first blurring layer 3 and the first data layer 4 are of the same color, such as yellow color or blue color.

The second blurring layer 5 is deposed on the first data layer 4, where the second blurring layer 5 comprises a second sectioned image area 51. The second blurring layer 5 comprises a different color from the color of the first data layer, which is blue color or red color. The second sectioned image area 51 is sectioned according to a geometric figure, such as circularly sectioned or wavily sectioned.

The second data layer 6 is deposed on the second blurring layer, where the second data layer 6 comprises a second image area 61 and a first grating 62 deposed on the second image area 61. Thus, with the above structure, a novel encrypted-data game card is obtained.

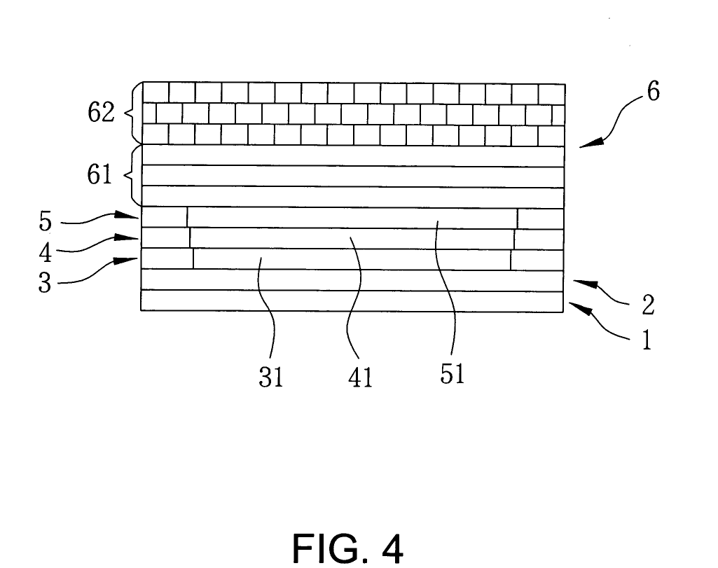

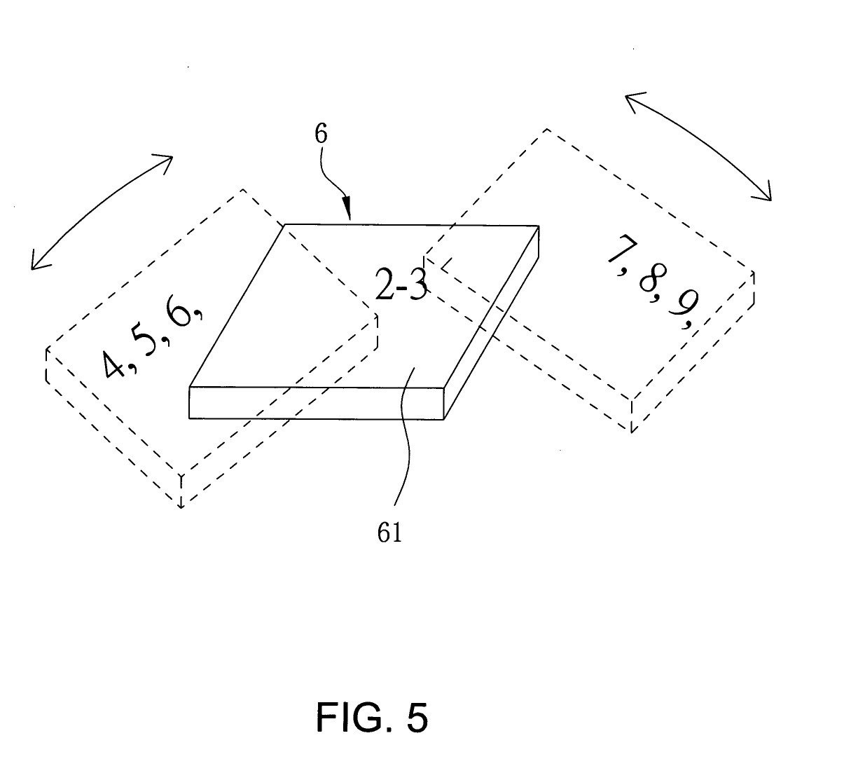

Please refer to FIG. 4 and FIG. 5, which are a cross-sectional view and a state-of-use view of a second preferred embodiment according to the present invention. As shown in the figures, the second data layer 6 comprises a plurality of second image areas 61 and a plurality of first gratings 62. When a user is recognizing the data on the second image areas 61, the user waves the game card upward, downward, leftward and rightward to watch the present invention from various visual angles so that the data on the second image areas 61 are recognized separately or wholly through the first gratings 62.

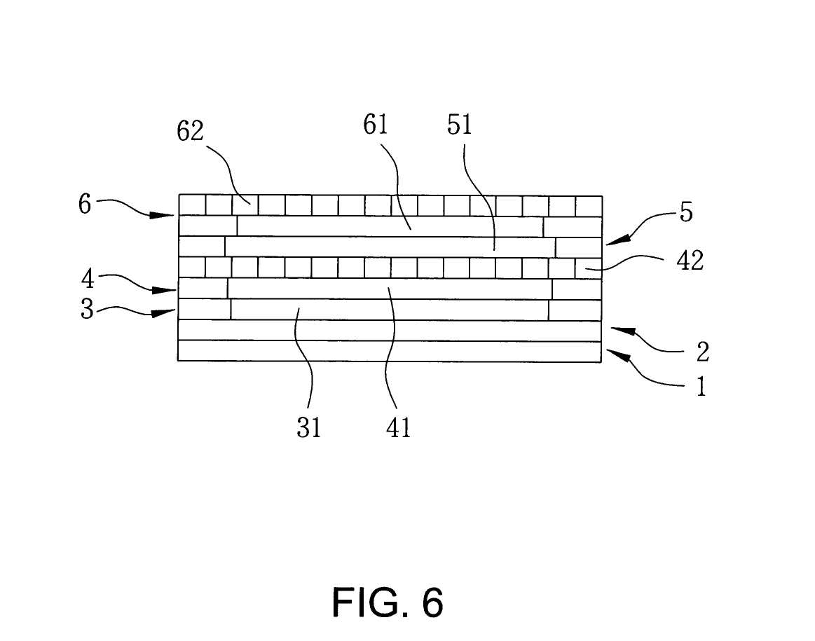

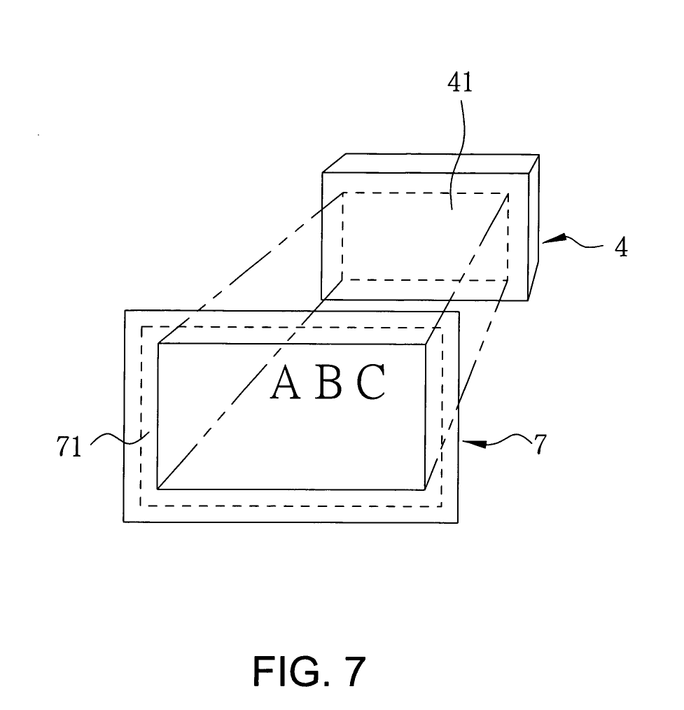

Please refer to FIG. 6 and FIG. 7, which are a cross-sectional view and a state-of-use view of a third preferred embodiment according to the present invention. As shown in the figures, a third grating 42 is set on the first data layer 4. When a user is recognizing the data on the first image area 41, a first filter lens 7 is used as corresponding to the game card to recognize the data on the first image area 41 through the first filter lens 7. In addition, the first filter lens 7 can further comprises a fourth grating 71 to recognize the data on the first image area 41. Hence, the data is encrypted to be used on paper money or security document.

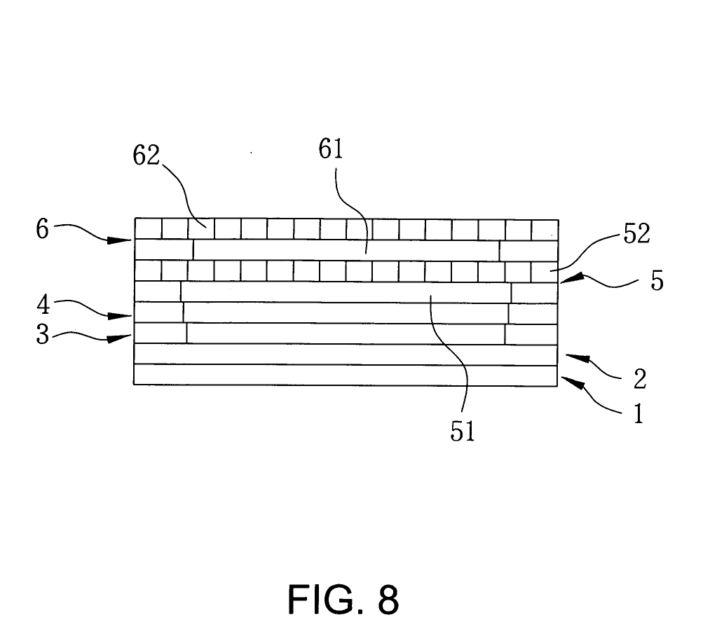

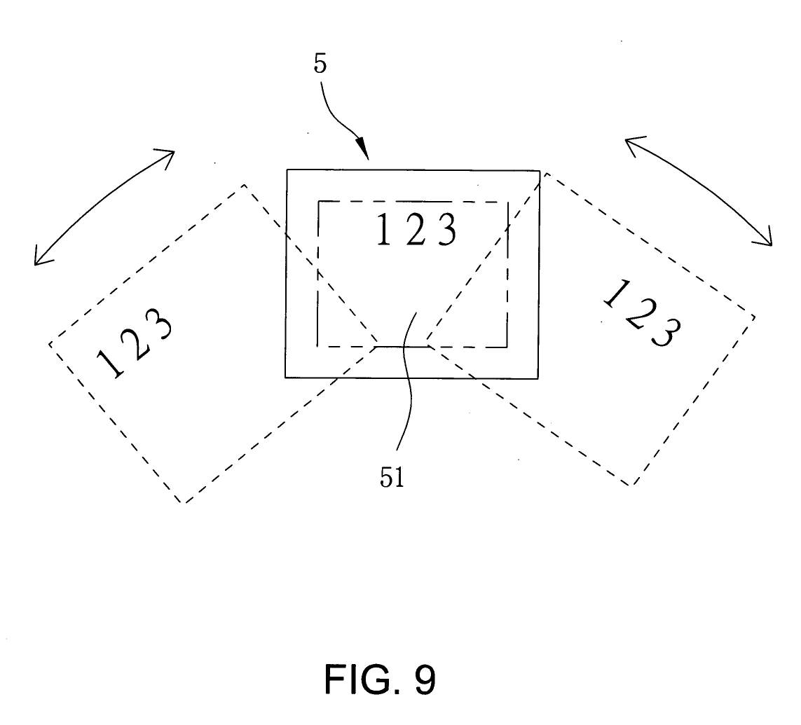

Please refer to FIG. 8 and FIG. 9, which are a cross-sectional view and a state-of-use view of a fourth preferred embodiment according to the present invention. As shown in the figures, a second grating 52 is set on the second blurring layer 5 so that, when the game card is moved, some of the data on the second sectioned image area are shown while some are hidden. Thus, a flickering effect is obtained and different parts of data on the second sectioned image area are seen from various visual angles.

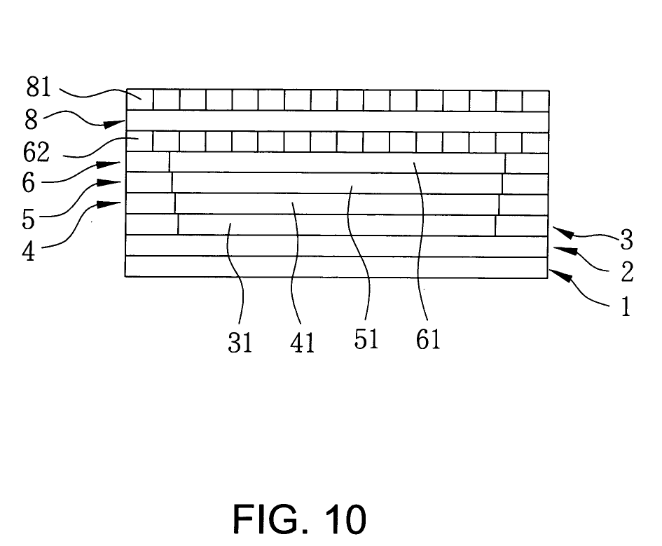

Please refer to FIG. 10, which is a cross-sectional view of a fifth preferred embodiment according to the present invention. As shown in the figure, a second filter lens 8 is deposed on the second grating 52, where the second filter lens 8 is corresponding to the game card to recognize data in the game card. In addition, a fifth grating 81 can be deposed on the second filter lens 8 so that different parts of data in the game card are recognized by watching from various visual angles through the fifth grating 81 while a flickering effect is obtained.

To sum up, the present invention is an encrypted-data game card, where data are encrypted and is recognized by watching from various visual angles or through a filter lens so that a good concealment and a high amusement are is obtained.

The preferred embodiments herein disclosed are not intended to unnecessarily limit the scope of the invention. Therefore, simple modifications or variations belonging to the equivalent of the scope of the claims and the instructions disclosed hereinfor a patent are all within the scope of the present invention.

What is claimed is:

1. An encrypted-data game card, comprising
a base layer;
an absorbing layer deposed on said base layer;
a first blurring layer deposed on said absorbing layer, said first blurring layer comprising a first sectioned image area;
a first data layer deposed on said first blurring layer, said first data layer comprising a first image area;
a second blurring layer deposed on said first data layer, said second blurring layer comprising a second sectioned image area; and
a second data layer deposed on said second blurring layer, said second data layer comprising a second image area and a first grating, said first grating deposed on said second image area.

2. The game card according to claim 1, wherein said base layer is made of a material selected from a group consisting of a plastic film, a transparent material and a semi-transparent material.

3. The game card according to claim 1, wherein said first blurring layer and said first data layer are of the same color.

4. The game card according to claim 3, wherein said color is selected from a group consisting of a yellow color and a blue color.

5. The game card according to claim 1 wherein said second blurring layer comprises a color selected from a group consisting of a blue color and a red color.

6. The game card according to claim 1, wherein said first and said second sectioned image areas are circularly sectioned.

7. The game card according to claim 1, wherein said first and said second sectioned image areas are wavily sectioned.

8. The game card according to claim 1 wherein a second grating is deposed on said second blurring layer to obtain an effect of flickering said sectioned image area.

9. The game card according to claim 1 wherein said first image area comprises an image, said image is a blank image with a border line.

10. The game card according to claim 1,
wherein a third grating is deposed on said first data layer; and
wherein said first image area is recognized by using a first filter

11. The game card according to claim 1 1 wherein a fourth grating is further deposed on said filter lens to recognize said first image area

12. The game card according to claim 1
wherein a plurality of second image areas and a plurality of first gratings are deposed on said second data layer and said first gratings are deposed on said second image areas; and
wherein said second image areas are recognized by watching from various angles through said first gratings in a way selected from a group consisting of recognizing said second image areas separately and recognizing said second image areas wholy.

13. The game card according to claim 1, wherein said game card further comprises a second filter lens deposed on said second data layer.

14. The game card according to claim 1, wherein a fifth grating is further deposed on said second filter lens.
